(19) United States
(12) Patent Application Publication
(10) Pub. No.: US 2026/0361540 A1
(43) Pub. Date: Nov. 12, 2026

(54) SYSTEM-ON-CHIP PERFORMING FUNCTION CONTROL USING SECURITY PROCESSOR, OPERATION METHOD OF THE SAME, AND COMPUTER PROGRAM FOR CONTROLLING FUNCTION OF SYSTEM-ON-CHIP

(71) Applicant: Samsung Electronics Co., Ltd., Suwon-si (KR)

(72) Inventors: Si-Heung KIM, Suwon-si (KR); Peng HUANG, Shaanxi Province (CN); Xingcong FU, Shaanxi Province (CN); Jin Soo PARK, Suwon-si (KR)

(21) Appl. No.: 19/572,827

(22) Filed: Mar. 19, 2026

(30) Foreign Application Priority Data
May 9, 2025 (CN) 202510604364.9
May 23, 2025 (KR) 10-2025-0067592

(51) Int. Cl. H04L 9/32

(52) U.S. Cl. CPC H04L 9/32

(57) ABSTRACT

There is provided a system-on-chip comprising: a main processor; a subsystem including a plurality of cores; and a security processor, wherein the security processor reads first control data for the main processor and the subsystem, the security processor determines a first frequency at which the main processor and the subsystem operate, and a first number of cores to be driven in the main processor and the subsystem according to the first control data, the security processor monitors whether the main processor and the subsystem operate according to the first frequency and the first number of cores at one or more preset periods, and the security processor controls the main processor and the subsystem to operate according to the first frequency and the first number of cores.

### CROSS-REFERENCE TO RELATED APPLICATION

This application claims priority from Chinese Patent Application No. 202510604364.9 filed on May 9, 2025, in the China National Intellectual Property Administration and Korean Patent Application No. 10-2025-0067592 filed on May 23, 2025, in the Korean Intellectual Property Office, and all the benefits accruing therefrom under 35 U.S.C. §119, the contents of which in their entirety are herein incorporated by reference.

### BACKGROUND

The present disclosure relates to a system-on-chip (SOC) that performs a function control using a security processor and an operation method thereof, and more particularly, to a method for controlling the frequency and number of cores of the system-on-chip in a security processor inside the system-on-chip.

Information of the system-on-chip is written on an OTP in the process, and the software or hardware operates on the basis of that information. Once the information is recorded, it may not be changed and it needs to operate only with that information. In general, products including the system-on-chip are manufactured dividedly into various grades depending on functions and performance, and higher grades may provide all the functions and performance of lower grades. The products including the system-on-chip are difficult to develop and verify without a real system-on-chip, due to the characteristics that they need to read the information provided by the system-on-chip to operate.

### SUMMARY

Due to difficulty in developing and verifying systems that include system-on-chips, some approaches use a method of storing specific information in a DRAM and utilizing the information stored in the DRAM instead of the information read from the hardware. However, since the DRAM is a space that may be read by other software and hardware, modulation of specific information is possible, and there is a problem that even if an access to the DRAM space is controlled, modulation may not be prevented when the access control method is exposed to a customer. Therefore, techniques capable of controlling the functions of the system-on-chip internally by the system-on-chip can help in reducing the risk of the product being used contrary to the specifications of the system-on-chip.

Aspects of the present disclosure provide a method for controlling the functions of the system-on-chip so that the system-on-chip does not operate differently from the preset specifications, by controlling the frequency and number of cores at which the system-on-chip operates in a security processor inside the system-on-chip.

Aspects of the present disclosure also provide a method for allowing the system-on-chip to operate at a lower specification, by controlling the functions through the security processor even if a defect occurs in some components of the system-on-chip.

There is provided a system-on-chip comprising: a main processor; a subsystem including a plurality of cores; and a security processor, wherein the security processor reads first control data for the main processor and the subsystem, the security processor determines a first frequency at which the main processor and the subsystem operate, and a first number of cores to be driven in the main processor and the subsystem according to the first control data, the security processor monitors whether the main processor and the subsystem operate according to the first frequency and the first number of cores at every preset period, and the security processor controls the main processor and the subsystem to operate according to the first frequency and the first number of cores, when the monitoring result shows that the frequency at which the main processor and the subsystem operate is operating differs from the first frequency, or when the number of cores by which the main processor and the subsystem are being driven differs from the first number of cores.

There is provided an operation method of a system-on-chip, comprising: reading first control data of the system-on-chip; determining a first frequency at which the system-on-chip operates and a first number of cores to be driven in the system-on-chip according to the first control data; monitoring whether the system-on-chip operates according to the first frequency and the first number of cores at every preset period; and controlling the system-on-chip to operate according to the first frequency and the first number of cores, when the monitoring result shows that the frequency at which the system-on-chip is operating differs from the first frequency, or when the number of cores by which the system-on-chip is being driven differs from the first number of cores.

There is provided a non-transitory computer-readable medium which stores a computer program, when a computer program is executed by a processor, the processor performs reading first control data of the system-on-chip; determining a first frequency at which the system-on-chip operates and a first number of cores to be driven in the system-on-chip according to the first control data; monitoring whether the system-on-chip operates according to the first frequency and the first number of cores at every preset period; and controlling the system-on-chip to operate according to the first frequency and the first number of cores, when the monitoring result shows that the frequency at which the system-on-chip is operating differs from the first frequency, or when the number of cores by which the system-on-chip is being driven differs from the first number of cores.

### BRIEF DESCRIPTION OF THE DRAWINGS

The above and other aspects and features of the present disclosure will become more apparent by describing in detail exemplary implementations thereof referring to the attached drawings.

FIG. 1 is a block diagram showing an exemplary configuration of an electronic device according to some implementations of the present disclosure.

FIG. 2 is a block diagram showing the operation of the electronic device according to some implementations of the present disclosure, dividedly into hardware and software.

FIG. 3 is a block diagram conceptually showing a system-on-chip function control process according to some implementations of the present disclosure.

FIG. 4 is a flowchart showing an example of a method for operating a system-on-chip according to some implementations of the present disclosure.

FIG. 5 is a flowchart showing some implementations of a step of reading first control data of FIG. 4.

FIG. 6 is a flowchart showing another implementation of the step of reading the first control data of FIG. 4.

FIG. 7 is a flowchart showing yet another implementation of the step of reading the first control data of FIG. 4.

FIG. 8 is a flowchart specifically showing a monitoring step of FIG. 4 and a step of controlling to operate according to the first frequency and the first number of cores.

FIG. 9 is a flowchart showing an example of a method of operating a system-on-chip according to another implementation of the present disclosure.

### DETAILED DESCRIPTION OF THE EMBODIMENTS

Hereinafter, implementations of the present disclosure will be described in detail with reference to the attached drawings. Advantages and features of the present disclosure, and a method of achieving the advantages and features will become apparent with reference to implementations described later in detail together with the accompanying drawings. However, implementations of the present disclosure are not limited to the implementations as disclosed below, but may be implemented in various different forms. Thus, these implementations are set forth only to make the present disclosure complete, and to completely inform the scope of the present disclosure to those of ordinary skill in the technical field to which the present disclosure belongs, and the present disclosure is only defined by the scope of the claims.

The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure gist of the present disclosure. Examples of various implementations are illustrated and described further below. It will be understood that the description herein is not intended to limit the claims to the specific implementations described. On the contrary, it is intended to cover alternatives, modifications, and equivalents as may be included within the spirit and scope of the present disclosure as defined by the appended claims.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The terminology used herein is directed to the purpose of describing particular implementations only and is not intended to be limiting of the present disclosure. As used herein, the singular constitutes "a" and "an" are intended to include the plural constitutes as well, unless the context clearly indicates otherwise.

Additionally, in describing the components of the present disclosure, terms such as first, second, A, B, a, and b may be used. These terms are only used to distinguish one component from another component, and the nature, sequence, order, or number of the component are not limited by the term. It should be understood that when a component is described as being “connected,” “coupled,” or “combined” to another component, the component may be directly connected, coupled, or combined to another component, still another component may be “interposed” therebetween, and thus the component may be connected, coupled, or combined to another component via the sill another component.

It will be further understood that the terms "comprise", "comprising", "include", and "including" as used herein specify the presence of the stated features, steps, operations, elements, and/or components, but do not preclude the presence or addition of one or more other features, steps, operations, elements, components, and/or portions thereof.

In this specification, the frequency at which the system-on-chip operates may refer to a frequency at which components of a main processor or a subsystem included in the system-on-chip operate. Further, in this specification, the number of cores by which the system-on-chip is driven may refer to the number of cores by which the components of the main processor or subsystem included in the system-on-chip are driven. The main processor included in the system-on-chip of the present disclosure may be realized as a CPU (Central Processing Unit), and the subsystem included in the system-on-chip may include a plurality of components, each of which includes a plurality of cores, such as a GPU (Graphics Processing Unit) or an NPU (Neural Processing Unit). In this specification, the expression that the subsystem includes the plurality of cores will be understood as meaning that each of the plurality of components included in the subsystem includes the plurality of cores.

That is, the frequency at which the system-on-chip operates may refer to any one of the frequencies at which the CPU, GPU, NPU, and the like included in the system-on-chip operate, and the number of cores by which the system-on-chip is driven may refer to any one of the number of cores to be actually driven among the plurality of cores included in the CPU, GPU, NPU, and the like included in the system-on-chip. Each component may operate depending on different frequencies or different number of cores, and the frequency or number of cores at which each component operates will be determined by control data to be described below.

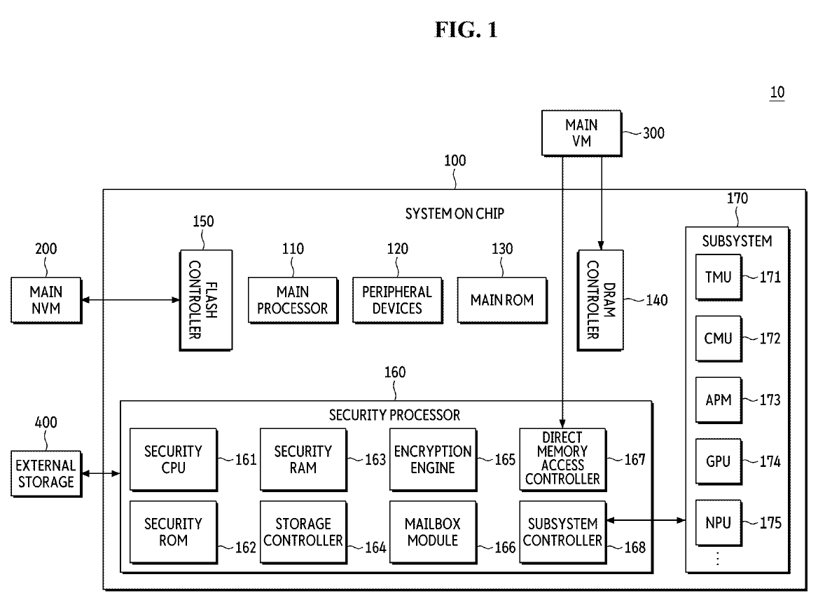

FIG. 1 is a block diagram showing an exemplary configuration of an electronic device 10 according to some implementations of the present disclosure. Referring to FIG. 1, the electronic device 10 may include a system-on-chip 100, a main non-volatile memory (NVM) 200, a main volatile memory (VOM) 300, and an external storage 400. The system-on-chip 100 may include a main processor 110, peripheral devices 120, a main read only memory (ROM) 130, a DRAM controller 140, a flash controller 150, a security processor 160, and a subsystem 170. For example, the electronic device 10 of FIG. 1 may be an electronic device included in a vehicle.

The main processor 110 may process the overall tasks of the system-on-chip 100. For example, the main processor 110 may load a boot loader into the main volatile memory 300 in response to power-on of the electronic device 10 to perform booting, and may control the operation of a host application. The main ROM 130 may store various types of control information required for the execution of host applications or the operation of the system-on-chip 100. For example, the various types of control information required for the operation of the system-on-chip 100 may include control data representing at what frequency and how many cores the components of the main processor 110 and the subsystem 170 operate.

The DRAM controller 140 may manage the main volatile memory 300. For example, the DRAM controller 140 may receive data for controlling the functions of the system-on-chip from the main non-volatile memory 200 and load it into the DRAM 300. The peripheral devices 120 may include devices for input/output of the electronic device 10. The flash controller 150 may write data to the main non-volatile memory 200 or read data from the main non-volatile memory 200.

The security processor 160 may include a security CPU 161, a security ROM 162, a security RAM 163, a storage controller 164, an encryption engine 165, a mailbox module 166, and a subsystem controller 168. The security CPU 161 may execute the overall operation of the security processor 160, using the security RAM 163 and the security ROM 162. For example, the security CPU 161 may be configured so that the main processor 110 and the subsystem 170 operate according to the frequency and number of cores represented by the control data.

Alternatively, the security CPU 161 may monitor whether each component of the main processor 110 and the subsystem 170 is operating according to the control data at one or more preset periods. In some implementations, the security CPU 161 can monitor at every preset period. Here, the monitoring may include the verification of the integrity of the control data. When the result of the monitoring shows that each component of the main processor 110 and the subsystem 170 is not operating according to the control data, each component of the main processor 110 and the subsystem 170 may be controlled to operate according to the frequency and the number of cores represented by the control data. Furthermore, the security CPU 161 may verify the integrity of the encrypted control data stored in the main non-volatile memory 200 or the external storage 400, and may be configured to update the encrypted control data to the latest state when the verification of the integrity fails.

The storage controller 164 may read data from the external storage 400 or write data to the external storage 400. For example, the storage controller 164 may read the encrypted control data from the external storage 400 or record the encrypted control data in the external storage 400.

The mailbox module 166 may perform a data communication between the security processor 160 and components outside the security processor 160 using the mailbox protocol. In some implementations, the mailbox module 166 includes a plurality of registers, and may communicate by receiving and classifying commands and data from an external configuration of the security processor 160.

The encryption engine 165 may encrypt input data, using a key. In some implementations, the encryption engine 165 may encrypt control data using a security key, and store it in the external storage 400. For example, the encryption engine 165 may encrypt the control data, using at least one algorithm among Hashed Message Authentication Code (HMAC), Rivest, Shamir, Adleman (RSA), and Elliptic Curve Digital Signature Algorithm (ECDSA). Alternatively, the encryption engine 165 may decrypt the encrypted control data that is read from the external storage 400 or the main non-volatile memory 200.

A direct memory access (DMA) controller 167 may be electrically connected to the main volatile memory 300 outside the security processor 160. The DMA controller 167 may access the external main volatile memory 300 to read data into the security processor 160. For example, the DMA controller 167 may read the control data cached in the security area of the main volatile memory 300 into the security processor 160.

The subsystem controller 168 may control the functions and operations of the components included in the subsystem 170 according to the frequency and number of cores represented by the control data. For example, the control data may include the frequency to operate and the number of cores to be driven for each component of the subsystem 170, and the subsystem controller 168 may control the frequency and number of cores of each component of the subsystem 170 accordingly.

The subsystem 170 may include a Thermal Management Unit (TMU) 171 for managing the temperature of the system on chip 100, a Clock Management Unit (CMU) 172 for managing the frequency at which the system on chip 100 operates, an Active Power Management (APM) unit for managing the power supply of the system on chip 100, and intellectual properties (IP) that perform data processing for providing various services to users (e.g., GPU (Graphics Processing Unit) 174, NPU (Neural Processing Unit) 175, etc.). Although not shown in FIG. 1, the subsystem 170 may further include an Image Signal Processor (ISP), a Tensor Processing Unit (TPU), etc. For example, the GPU 174 and the NPU 175 may communicate with the subsystem controller 168 and operate according to the frequency and number of cores represented by the control data.

The external storage 400 may refer to a non-volatile memory directly connected to the security processor 160 inside the system on chip 100. Since the external storage 400 only communicates with the security processor 160 inside the system-on-chip 100, it is processed by the security processor 160 and may store data that requires security. For example, the security processor 160 may store encrypted control data in the external storage 400. In some cases, the security processor 160 may compare the time point at which the encrypted control data stored in the external storage 400 is generated with the time point at which the encrypted control data stored in the main non-volatile memory 200 is generated, and when the encrypted control data stored in the external storage 400 is more recent data, the security processor 160 may decrypt the encrypted control data stored in the external storage 400 and read it as the control data.

The main non-volatile memory 200 may refer to a non-volatile memory that is accessible by the main processor 110 and the security processor 160. For example, the main processor 110 may access the main non-volatile memory 200 to drive a boot loader. Alternatively, the security processor 160 may access the main volatile memory 300 to read cached control data, but the security processor 160 may also directly access the main non-volatile memory 200 to read the control data when the system-on-chip 100 is started up.

The main non-volatile memory 200 and the external storage 400 may be configured as a non-volatile memory in which stored data does not disappear when the power supply is cut off. For example, the main NVM 200 and the security NVM 400 may include a NAND flash memory (NAND), a vertical NAND flash memory (Vertical NAND), a NOR flash memory, a resistive random access memory, a phase-change memory, magnetoresistive random access memory, and the like.

The main volatile memory 300 may be a memory that is accessible by the host application and the security processor 160. For example, the main volatile memory 300 may load the main firmware and perform booting. The main volatile memory 300 may be configured as a memory in which stored data disappears when the power supply is cut off. For example, the main volatile memory 300 may include a static random access memory (SRAM), a dynamic random access memory (DRAM), and a magnetoresistive memory. Hereinafter, the main volatile memory 300 will be described on the basis of being implemented as a DRAM 300, but the present disclosure is not limited thereto.

On the other hand, if a defect occurs in the main processor 110, some components of the subsystem 170, or components related to the timer or power supply of the system-on-chip 100, and the system-on-chip 100 is not able to operable according to the frequency and number of cores represented by the control data, the security processor 160 may control the system-on-chip 100 to operate according to a lower frequency or a lower number of cores, by reading the new control data.

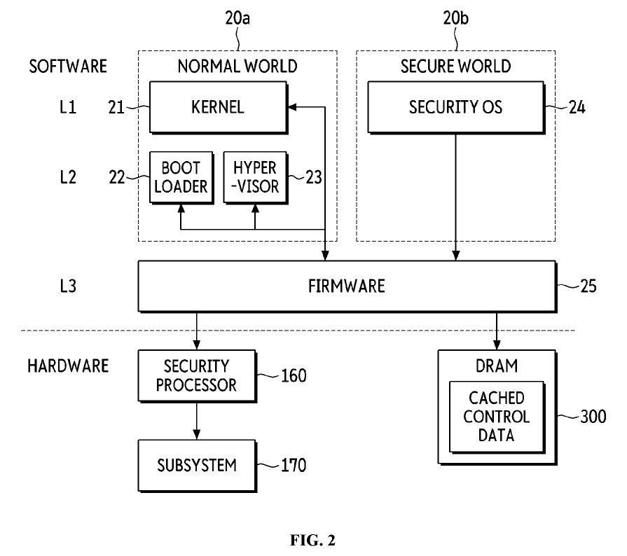

FIG. 2 is a block diagram showing the operation of an electronic device (10 of FIG. 1) according to some implementations of the present disclosure, dividedly into hardware and software. The following description will be made referring to FIG. 1 together with FIG. 2. The main processor 110 may perform selective operations in either the normal world 20a or the secure world 20b.

The secure world 20b may refer to a data processing architecture that ensures security, and the normal world 20a may refer to a general data processing architecture. For example, the main processor 110 may operate on the basis of “ARM Trust Zone Architecture”. The above architecture may include two runtime environments, and a non-secure runtime environment (e.g., REE (Rich Execution Environment)) as one of them may be called the normal world 20a and may be controlled by a normal operating system. For example, the normal operating system may be a conventional operating system such as Android, Windows Phone, iOS (iPhone OS), etc.

A secure runtime environment (e.g., Trusted Execution Environment (TEE)) which is the other runtime environment, may be called the secure world 20b, and the secure runtime environment may be controlled by a security operating system 24. For example, the security operating system 24 may be an operating system that inserts a security kernel with security functions integrated into an existing operating system.

A kernel 21 operates on the first layer L1 of the normal world 20a, a boot loader 22 and a hypervisor 23 operate on the second layer L2, and a firmware 25 may operate on the third layer L3. The kernel 21, the boot loader 22, and the hypervisor 23 may be programs executed on a normal operating system by the main processor 110, and it may be understood that the following operations of the kernel 21, the boot loader 22, and the hypervisor 23 are executed by the main processor 110.

After the system-on-chip 100 is started up, the kernel 21 may transfer encrypted control data stored in the main non-volatile memory 200 or encrypted control data stored in the external storage 400 to the firmware 25 while the normal operating system is running. The boot loader 22 may be loaded into the DRAM 300 when the system-on-chip 100 is started up, and the encrypted control data stored in the main non-volatile memory 200 may be transferred to the firmware 25 through the hypervisor 23.

The firmware 25 corresponds to a firmware in which security is verified for transmitting and receiving signals between the kernel 21, the hypervisor 23, or the security operating system 24. A module included in the firmware 25 may communicate with the security processor 160 to transfer the encrypted control data to the security processor 160. Alternatively, a module included in the firmware 25 may communicate with the DRAM (main volatile memory 300 of FIG. 1) to transfer the cached control data to the security processor 160.

As described referring to FIG. 1, the security processor 160 may monitor whether the main processor 110 and the subsystem 170 are operating according to the control data transferred through the firmware 25. Each component of the subsystem 170 requires various types of software for operation, and each piece of software requires a module for communicating with the security processor 160.

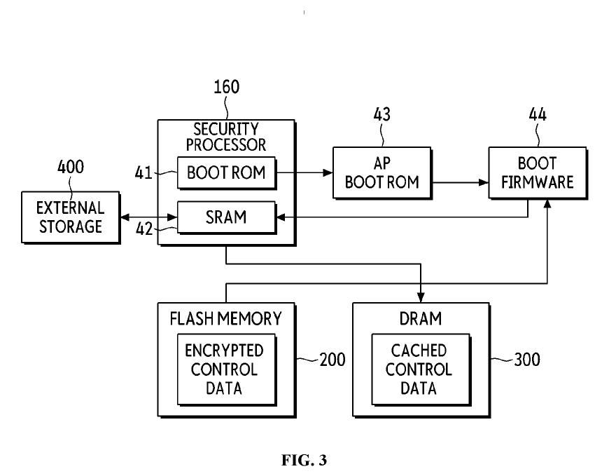

FIG. 3 is a block diagram conceptually showing a system-on-chip function control process according to some implementations of the present disclosure. The following description will be given referring to FIGS. 1 and 2 in conjunction with FIG. 3.

When the system-on-chip 100 is first powered on, the security processor 160 may be driven. While the flash memory 200 is being initialized after the system-on-chip 100 is started up, the encrypted control data stored in the flash memory 200 may be provided to the security processor 160. Specifically, the encrypted control data stored previously in the flash memory 200 may be provided to the boot firmware 44, and the security processor 160 communicates with the boot firmware 44 through the boot ROM 41 and the AP boot ROM 43 in the course of the startup process of the system-on-chip 100, and may receive the encrypted control data provided to the boot firmware 44.

Meanwhile, the security processor 160 may back up the provided encrypted control data to the external storage 400 connected through the SRAM 42. As a result, even if verification of the provided encrypted control data in the startup process fails, the encrypted control data backed up in the external storage 400 may be used instead. Furthermore, in the initialization step of the system-on-chip 100, data needs to be read and written frequently. However, if the data exists only inside the security processor 160, a time delay due to communication may occur. Therefore, such a time delay may be eliminated by storing the cached control data in the security area of the DRAM 300 and then providing the security processor 160 with the control data from the DRAM 300. Because the security area of the DRAM 300 may communicate only with the security processor 160 and the security operating system (24 of FIG. 2) that communicates with the security processor 160, a high level of security may be ensured.

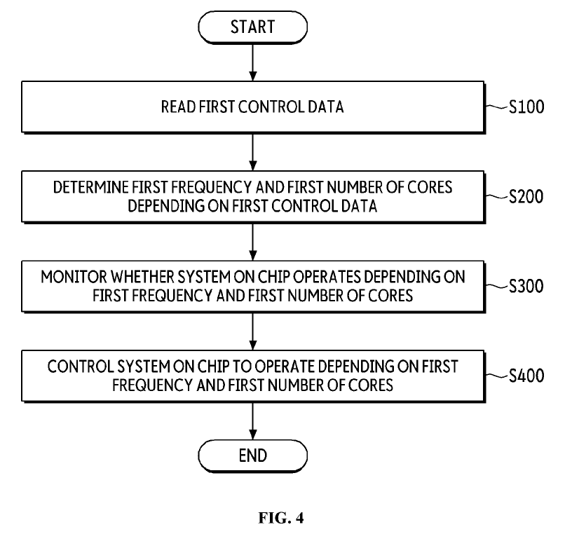

FIG. 4 is a flow chart showing an exemplary method of operating a system-on-chip according to some implementations of the present disclosure. For reference, FIGS. 4 and 5-9 to be described later show steps/operations performed in the system-on-chip 100 of FIG. 1, particularly the security processor 160. Therefore, in the following descriptions, when the subject of a particular step/operation is omitted, it may be understood that the step/operation is performed by the system-on-chip 100 or the security processor 160 of FIG. 1.

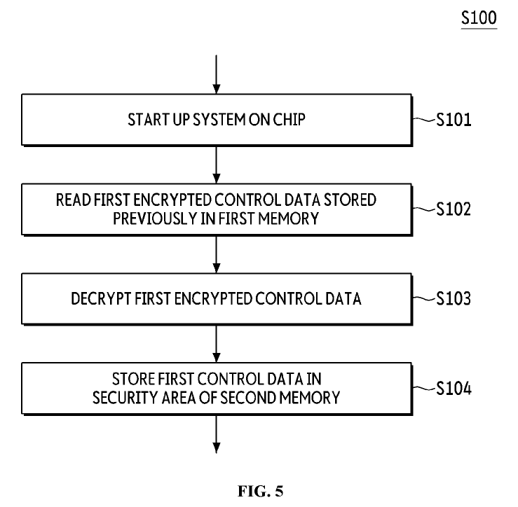

In step S100, the first control data may be read. Hereinafter, implementations of step S100 will be discussed referring to FIGS. 5-7.

FIG. 5 is a flowchart showing an implementation of step S100 of reading the first control data of FIG. 4. Referring to FIG. 5, in step S101, the system-on-chip 100 may be started up. For example, the start-up of the system-on-chip 100 may be performed by loading the boot loader 22 of FIG. 2 into the main volatile memory 300. In step S102, after the system-on-chip 100 starts up, the first encrypted control data stored previously in the first memory may be read. Here, the first memory may correspond to the main non-volatile memory 200. In step S103, the first encrypted control data may be decrypted, and read as the first control data. For example, the decryption of the first encrypted control data may be performed by the encryption engine 165. Next, in step S104, the first control data may be stored in a security area of a second memory different from the first memory. For example, the second memory may correspond to the main volatile memory 300.

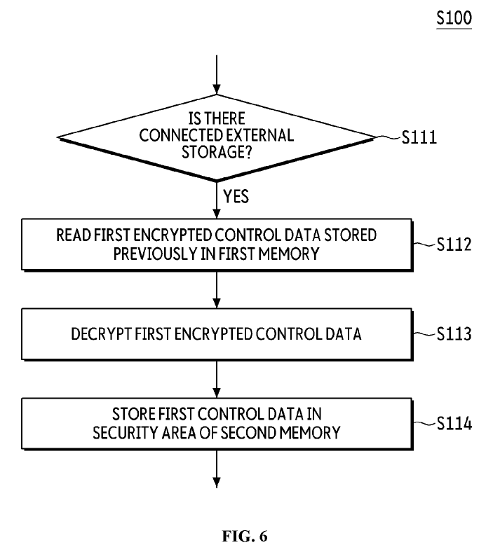

FIG. 6 is a flow chart showing another implementation of step S100 of reading the first control data of FIG. 4. Referring to FIG. 6, in step S111, after the system-on-chip 100 is started up, it may be determined whether there is an external storage 400 connected to the system-on-chip 100. If there is a connected external storage 400 (YES), in step S112, the first time point at which the first encrypted control data is generated may be compared with the second time point at which the second encrypted control data stored in the external storage 400 is generated. In step S113, if the second time point is earlier than the first time point, the second encrypted control data may be read, and in step S114, the second encrypted control data may be decrypted and read as the first control data. In some implementations, where the first encrypted control data is decrypted and read as the first control data, the decrypted first encrypted control data is replaced with the decrypted second encrypted control data for use as the first control data. The updated first control data can be stored in the security area of the second memory.

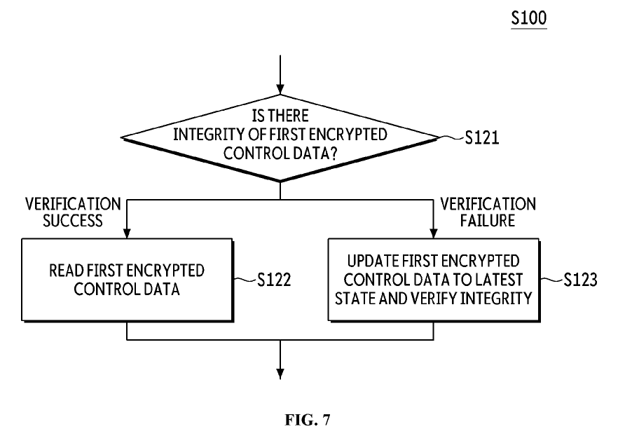

FIG. 7 is a flowchart showing yet another implementation of step S100 of reading the first control data of FIG. 4. Referring to FIG. 7, in step S121, the integrity of the first encrypted control data may be verified. If the verification succeeds, in step S122, the first encrypted control data may be read, and if the verification fails, in step S123, the first encrypted control data may be updated to the latest state and the integrity of the updated first encrypted control data may be verified again.

Returning to FIG. 4, in step S200, the first frequency at which the system-on-chip 100 operates and the first number of cores to be driven in the system-on-chip 100 may be determined depending on the first control data. Here, the operation of the system-on-chip 100 means the operation of the main processor 110 and the subsystem 170, and the first frequency and the first number of cores may be set differently for each component of the main processor 110 and the subsystem 170 of the system-on-chip 100. For example, the first frequency and the first number of cores may be set differently depending on which function each component performs.

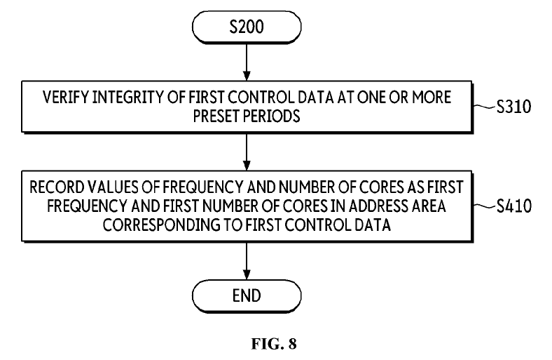

In step S300, it is possible to monitor whether the system-on-chip 100 operates according to the first frequency and the first number of cores at one or more preset periods. In some implementations, the system-on-chip can be monitored at every preset period. In step S400, if the monitoring result shows that the frequency at which the system-on-chip 100 is operating differs from the first frequency, or if the number of cores being driven in the system-on-chip 100 is different from the first number of cores, the system-on-chip 100 may be controlled to operate according to the first frequency and the first number of cores. Here, the cases where the operating frequency is different from the first frequency and the number of cores being driven is different from the first number of cores also include a case where the operating frequency and the number of cores being driven are smaller than the first frequency and the first number of cores, but may also include a case where they are larger than the first frequency and the first number of cores. Hereinafter, steps S300 and S400 will be considered referring to FIG. 8.

FIG. 8 is a flowchart specifically showing the monitoring step S300 and the controlling step S400 to operate according to the first frequency and the first number of cores of FIG. 4. Referring to FIG. 8, in step S310, the integrity of the first control data may be verified at one or more preset periods. In some implementations, the integrity of the first control data may be verified at every preset period. Further, in step S410, the values of the frequency and the number of cores in the address area corresponding to the first control data may be changed to the first frequency and the first number of cores and recorded. In this way, if the verification of the integrity fails, the control data may be kept to a latest state.

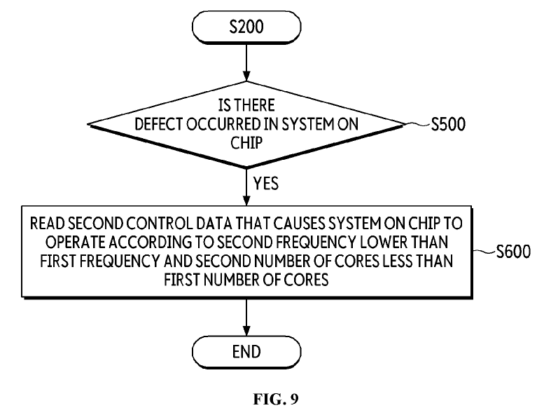

FIG. 9 is a flowchart showing an example of an operation method of a system-on-chip according to another implementation of the present disclosure. Referring to FIG. 9, after step S400, in step S500, it may be determined whether a defect has occurred in at least one of the processor, the timer, and the power supply included in the system-on-chip 100. If a defect has occurred (YES), in step S600, second control data that causes the system-on-chip 100 to operate according to a second frequency lower than the first frequency and a second number of cores less than the first number of cores may be read. In this way, even if a defect occurs in the system-on-chip 100, the product can be continuously used without directly replacing the system-on-chip 100.

The function control method of the system-on-chip according to some implementations of the present disclosure may be implemented as program code stored in a non-transitory computer-readable medium. For example, the non-transitory computer-readable medium may be included in a magnetic medium, an optical medium or a combination thereof (e.g., a CD-ROM, a hard drive, a read-only memory, a flash drive, etc.).

For example, the non-transitory computer-readable medium may include program code which, when executed, causes a processor to read first control data of the system-on-chip, determine a first frequency at which the system-on-chip operates and a first number of cores to be driven in the system-on-chip according to the first control data, monitor whether the system-on-chip operates according to the first frequency and the first number of cores at one or more preset periods, and control the system-on-chip to operate according to the first frequency and the first number of cores, when the frequency at which the system-on-chip is operating differs from the first frequency, or when the number of cores at which the system-on-chip is driving is different from the initial number of cores.

According to some implementations of the present disclosure, the control data regarding the function and performance of the system-on-chip is stored in a separate space called a security processor, and the information may be continuously maintained by transferring the information stored in the security processor to the upper software. According to some implementations of the present disclosure, because the stored information may be updated and the system-on-chip may be operated according to the updated information, even if the existing function of the product equipped with the system-on-chip is updated or a new function is downloaded, the product may be continuously used. Further, according to some implementations of the present disclosure, by controlling the function and performance of the product through the control data including the frequency to be operated and the number of cores to be driven, a product with a defect that occurred when manufacturing the product may be utilized as a product with lower performance, thereby improving productivity and utilizing the product again as a product with lower performance, even if a defect occurs later. Furthermore, according to some implementations of the present disclosure, since the control data is stored in a separate space called a security processor, it is possible to prevent the system-on-chip from operating with specifications other than those set by the manufacturer.

A specific function may be added or restricted through the software of the electronic device included in the vehicle, using the implementations of the present disclosure. For example, assume that the main processor and subsystem of the system-on-chip of the electronic device included in the current vehicle operate according to the first frequency and the first number of cores. According to some implementations of the present disclosure, control data representing the first frequency and the first number of cores may be stored in the security processor of the system-on-chip. At this time, the control data may be updated to indicate a second frequency and a second number of cores that are greater than the first frequency and the first number of cores through a software update, and thus, a system-on-chip of an electronic device included in a vehicle may operate according to the second frequency and the second number of cores. Accordingly, the vehicle may provide a user with better functionality (e.g., more accurate autonomous driving functionality) than a case where the vehicle operates at the first frequency and the first number of cores.

Various implementations of the present disclosure and the effects according to those implementations have been mentioned above with reference to FIGS. 1-9, The effects according to the technical idea of the present disclosure are not limited to the effects as mentioned above, and other effects not mentioned may be clearly understood by those skilled in the art from the above descriptions.

All the components that constitute the implementations of the present disclosure are described as being combined with each other or operating in combination with each other. However, the present disclosure is not necessarily limited to these implementations. In other words, within the scope of the purpose of the present disclosure, all of the components may operate in a selective combination manner of at least two thereof with each other.

Although the operations are shown as being executed in a specific order in the drawings, it should not be understood that the operations should be performed in the specific order as shown or in a sequential order or that all illustrated operations should be performed to obtain the desired result.

As used herein, the term “at least one of” can refer to and encompass any and all possible combinations of one or more of the associated listed terms. For example, the term “at least one of A, B, or C” means that (i) at least one of A, (ii) at least one of B, (iii) at least one of C, (iv) at least one of A and at least one of B, (v) at least one of B and at least one of C, (vi) at least one of A and at least one of C, or (vi) at least one of A, at least one of B and at least one of C are possible, where A, B and C may be singular or plural.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Although implementations of the present disclosure have been described with reference to the accompanying drawings, implementations of the present disclosure are not limited to the above implementations, but may be implemented in various different forms. A person skilled in the art may appreciate that the present disclosure may be practiced in other concrete forms without changing the technical spirit or essential characteristics of the present disclosure. Therefore, it should be appreciated that the implementations as described above is not restrictive but illustrative in all respects.

What is claimed is:

1. A system-on-chip comprising:
a main processor;
a subsystem comprising a plurality of cores; and
a security processor,
wherein the security processor is configured to
read first control data for the main processor and the subsystem, determine a first frequency at which the main processor and the subsystem operate, and a first number of cores to be driven in the main processor and the subsystem according to the first control data,
monitor whether the main processor and the subsystem operate according to the first frequency and the first number of cores at one or more preset periods, and
control the main processor and the subsystem to operate according to the first frequency and the first number of cores, based on identifying at least one of (i) a frequency at which the main processor and the subsystem operate are operating differs from the first frequency, or (ii) a number of cores by which the main processor and the subsystem are being driven differs from the first number of cores.

2. The system-on-chip of claim 1,
wherein the subsystem comprises at least one of a thermal management unit (TMU), a clock management unit (CMU), an active power management (APM) unit, a graphics processing unit (GPU), or a neural processing unit (NPU).

3. The system-on-chip of claim 1,
wherein the security processor is configured to:
start the system-on-chip,
decrypt first encrypted control data from a first memory to provide decrypted first control data, and
read the decrypted first control data and use as the first control data.

4. The system-on-chip of claim 3,
wherein the security processor is configured to store the first control data in a security area of a second memory that is different from the first memory.

5. The system-on-chip of claim 3,
wherein the security processor is configured to:
compare a first time point at which the first encrypted control data is generated with a second time point at which a second encrypted control data is generated, wherein the second encrypted control data is stored in an external storage,
read the second encrypted control data based on the second time point being earlier that the first time point,
decrypt the second encrypted control data to provide decrypted second control data, and
replace the decrypted first control data with the decrypted second control data for use as the first control data.

6. The system-on-chip of claim 3,
wherein the security processor is configured to
verify integrity of the first encrypted control data,
based on a successful verification of integrity of the first encrypted control data, read the first encrypted control data, or
based on a failed verification of integrity of the first encrypted control data, update the first encrypted control data to a latest state, and verify the integrity of an updated first encrypted control data.

7. The system-on-chip of claim 1,
wherein the security processor is configured to
read, based on an occurrence of defect in at least one of the main processor, the subsystem, a timer, or a power supply of the system-on-chip, second control data, cause the main processor and the subsystem to operate at a second frequency lower than the first frequency and cause the main processor and the subsystem to operate at a second number of cores less than the first number of cores.

8. The system-on-chip of claim 1,
wherein the security processor is configured to
verify integrity of the first control data at the one or more preset periods, and
record, based on identifying that the frequency at which the system-on-chip is operating differs from the first frequency or the number of cores by which the system-on-chip is being driven differs from the first number of cores, values of the frequency and the number of cores as the first frequency and the first number of cores, respectively, in an address area corresponding to the first control data.

9. An operation method of a system-on-chip, comprising:
reading first control data of the system-on-chip;
determining a first frequency at which the system-on-chip operates and a first number of cores to be driven in the system-on-chip according to first control data;
monitoring whether the system-on-chip operates according to the first frequency and the first number of cores at one or more preset periods; and
controlling the system-on-chip to operate according to the first frequency and the first number of cores, when a monitoring result indicates at least one of (i) a frequency at which the system-on-chip is operating differs from the first frequency, or (ii) a number of cores by which the system-on-chip is being driven differs from the first number of cores.

10. The operation method of the system-on-chip of claim 9,
wherein reading the first control data of the system-on-chip comprises:
starting up the system-on-chip;
reading first encrypted control data stored in a first memory, after the system-on-chip starts up; and
decrypting the first encrypted control data to provide decrypted first control data, and using the decrypted first control data as the first control data.

11. The operation method of the system-on-chip of claim 10,
wherein reading the first control data of the system-on-chip comprises:
storing the first control data in a security area of a second memory different from the first memory.

12. The operation method of the system-on-chip of claim 10,
wherein reading the first control data of the system-on-chip comprises:
comparing a first time point at which the first encrypted control data is generated with a second time point at which a second encrypted control data is generated;
based on determining that the second time point is earlier than the first time point, reading the second encrypted control data; and
decrypting the second encrypted control data to provide decrypted second control data and replace the decrypted first control data with the decrypted second control data for use as the first control data.

13. The operation method of the system-on-chip of claim 10,
wherein reading the first encrypted control data stored in the first memory comprises:
verifying integrity of the first encrypted control data;
based on a successful verification of integrity of the first encrypted control data, reading the first encrypted control data; or
based on a failed verification of integrity of the first encrypted control data, updating the first encrypted control data to a latest state, and verifying integrity of an updated first encrypted control data.

14. The operation method of the system-on-chip of claim 9,
wherein the system-on-chip reads second control data for causing the system-on-chip to operate according to a second frequency lower than the first frequency and a second number of cores less than the first number of cores based on identifying occurrence of defect in at least one of a processor, a timer or a power supply of the system-on-chip.

15. The operation method of the system-on-chip of claim 9,
wherein monitoring comprises verifying integrity of the first control data at the one or more preset periods, and
controlling of the system-on-chip to operate according to the first frequency and the first number of cores comprises recording values of the frequency and number of cores as the first frequency and the first number of cores, respectively, in an address area corresponding to the first control data.

16. A non-transitory computer-readable medium storing instructions that when executed by one or more processors cause the one or more processors to perform operations comprising:
reading first control data of a system-on-chip;
determining a first frequency at which the system-on-chip operates and a first number of cores to be driven in the system-on-chip according to first control data;
monitoring whether the system-on-chip operates according to the first frequency and the first number of cores at one or more preset periods; and
controlling the system-on-chip to operate according to the first frequency and the first number of cores, when a monitoring result indicates at least one of (i)a frequency at which the system-on-chip is operating differs from the first frequency, or (ii) a number of cores by which the system-on-chip is being driven differs from the first number of cores.

17. The non-transitory computer-readable medium of claim 16,
wherein reading the first control data of the system-on-chip comprises:
starting up the system-on-chip;
reading first encrypted control data stored in a first memory, after the system-on-chip starts up; and
decrypting the first encrypted control data to provide decrypted first control data, and using the decrypted first control data as the first control data.

18. The non-transitory computer-readable medium of claim 17,
wherein reading the first control data of the system-on-chip comprises:
storing the first control data in a security area of a second memory different from the first memory.

19. The non-transitory computer-readable medium of claim 17,
wherein reading the first control data of the system-on-chip comprises:
comparing a first time point at which the first encrypted control data is generated with a second time point at which a second encrypted control data is generated;
based on a determining that the second time point is earlier than the first time point, reading the second encrypted control data; and
decrypting the second encrypted control data to provide decrypted second control data and replace the decrypted first control data with the decrypted second control data for use as the first control data.

20. The non-transitory computer-readable medium of claim 17,
wherein reading the first encrypted control data stored in the first memory comprises:
verifying integrity of the first encrypted control data;
based on a successful verification of integrity of the first encrypted control data, reading the first encrypted control data; or
based on a failed verification of integrity of the first encrypted control data, updating the first encrypted control data to a latest state, and verifying integrity of an updated first encrypted control data.
